(19) United States
(12) Patent Application Publication
(10) Pub. No.: US 2026/0240329 A1
(43) Pub. Date: Aug. 20, 2026

(54) CHILD SEAT ILLUMINATION SYSTEM

(71) Applicant: WONDERLAND SWITZERLAND AG, Steinhausen (CH)

(72) Inventors: Bruce L. Williams, Morgantown, PA (US); Gregory S. Sellers, Morgantown, PA (US)

(21) Appl. No.: 19/129,818

(22) PCT Filed: Nov. 17, 2023
(86) PCT No.: PCT/US2023/080375

§ 371 Date: May 14, 2025

Related U.S. Application Data
(60) Provisional application No. 63/426,937, filed on Nov. 21, 2022.
(60) Provisional application No. 63/496,528, filed on Apr. 17, 2023.
(60) Provisional application No. 63/500,109, filed on May 4, 2023.
(60) Provisional application No. 63/500,798, filed on May 8, 2023.
(60) Provisional application No. 63/581,050, filed on Sep. 7, 2023.
(60) Provisional application No. 63/595,120, filed on Nov. 1, 2023.

(51) Int. Cl. A47C 7/72; B60N 2/28; B60Q 3/233; B60Q 3/242

(52) U.S. Cl. CPC A47C 7/725; B60N 2/28; B60Q 3/233; B60Q 3/242

(57) ABSTRACT

A child seat mountable to a transportation device includes a seat body including a seat shell having a child seat pan and a child seat back. The seat body is securable to the transportation device. At least one light is mounted about the seat body.

### CROSS REFERENCE TO RELATED APPLICATIONS

This application claims the benefit of U.S. Application No. 63/426,937, filed on Nov. 21, 2022, U.S. Application No. 63/496,528, filed on Apr. 17, 2023, U.S. Application No. 63/500,109, filed on May 4, 2023, U.S. Application No. 63/500,798, filed on May 8, 2023, U.S. Application No. 63/581,050, filed on Sep. 7, 2023, and U.S. Application No. 63/595,120, filed Nov. 1, 2023, which is incorporated herein by reference in its entirety.

### BACKGROUND

Exemplary embodiments of the disclosure relative to child safety seats for use in a vehicle.

A child safety seat is used to transport children and is typically designed for use in an automobile to properly restrain a child in the event of accident. Some infant carriers are designed not only to form part of the child safety seat within a vehicle, but also to attach to a stroller to form a travel system. The limited light provided within a vehicle at night can make it difficult for a user to either install or properly position a car seat within the vehicle, or properly arrange a child within an installed car seat.

### BRIEF DESCRIPTION

The foregoing needs are met, to a great extent, by the child seat disclosed in the present application. In particular, the child seat disclosed herein provides for a variety of lighting on the exterior of the child seat to provide adequate illumination to facilitate install, positioning, and securement of the child seat on a vehicle seat or other support structure (e.g., a stroller). The lighting can be strategically located to illuminate a vehicle seating area of the vehicle seat, a pre-installed car seat base, or other support structures.

The lighting can be activated using manually activated controls or controls that are strategically placed on the child seat (e.g., a handle, a body of the car set, etc.). Alternatively, the lighting can be automatically activated by certain contextual situations or actions. For example, the lights can be activated by rotating or transitioning ISOFIX connectors to a use position, using sensors that detect the proximity of the child seat to the vehicle seat or other support structure, or still other methods to activate the lights.

According to an embodiment, a child seat mountable to a transportation device includes a seat body including a seat shell having a child seat pan and a child seat back. The seat body is securable to the transportation device. At least one light is mounted about the seat body.

In addition to one or more of the features described above, or as an alternative, in further embodiments the at least one light is positioned such that the at least one light is operable to illuminate an interface between the child seat and the transportation device.

In addition to one or more of the features described above, or as an alternative, in further embodiments the transportation device is an automobile including a vehicle seat.

In addition to one or more of the features described above, or as an alternative, in further embodiments the seat body includes a connector of a LATCH system and the at least one light is operable to illuminate the connector.

In addition to one or more of the features described above, or as an alternative, in further embodiments the seat body includes a vehicle belt path for a vehicle belt associated with the vehicle seat. The at least one light is operable to illuminate a portion of the vehicle belt path.

In addition to one or more of the features described above, or as an alternative, in further embodiments the seat body includes at least one vehicle belt guide tab defining the portion of the vehicle belt path. The at least one light is operable to illuminate the at least one vehicle belt guide tab.

In addition to one or more of the features described above, or as an alternative, in further embodiments a groove formed at the child seat back defines the portion of the vehicle belt path. The at least one light is operable to illuminate the groove.

In addition to one or more of the features described above, or as an alternative, in further embodiments the child seat is connectable to the transportation device via a seat receiving member and the at least one light is positioned about the child seat such that the at least one light is operable to illuminate an interface between the child seat and the seat receiving member.

In addition to one or more of the features described above, or as an alternative, in further embodiments the transportation device is a stroller and the seat receiving member is a support member of the stroller.

In addition to one or more of the features described above, or as an alternative, in further embodiments the seat body includes a carrying handle movably mounted to the seat shell. The at least one light is positioned adjacent to the carrying handle.

In addition to one or more of the features described above, or as an alternative, in further embodiments the child seat is an infant child seat.

In addition to one or more of the features described above, or as an alternative, in further embodiments the seat receiving member is a support base and the transportation device is an automobile including a vehicle seat.

In addition to one or more of the features described above, or as an alternative, in further embodiments the child seat is connectable to the transportation device via a seat receiving member. The at least one light is positioned about the child seat to illuminate an interface between the seat receiving member and the transportation device.

In addition to one or more of the features described above, or as an alternative, in further embodiments the at least one light is oriented to emit light towards the seat receiving member.

In addition to one or more of the features described above, or as an alternative, in further embodiments the at least one light is oriented to emit light towards a portion of the transportation device.

In addition to one or more of the features described above, or as an alternative, in further embodiments the at least one light includes at least one light source.

In addition to one or more of the features described above, or as an alternative, in further embodiments the at least one light source includes a plurality of light sources.

According to an embodiment, a child seat mountable to a transportation device includes a seat body including a seat shell and at least one light mounted about the seat body. The at least one light is activatable in response to an input to the seat body.

In addition to one or more of the features described above, or as an alternative, in further embodiments the seat body includes a connector of a LATCH system and the at least one light is activatable in response to movement of the connector.

In addition to one or more of the features described above, or as an alternative, in further embodiments the seat body includes a carrying handle movably mounted to the seat shell. The at least one light is activatable in response to movement of the carrying handle.

In addition to one or more of the features described above, or as an alternative, in further embodiments the seat body includes a release mechanism having an actuator. The at least one light is activatable in response to application of a force to the actuator.

In addition to one or more of the features described above, or as an alternative, in further embodiments the child seat is an infant child seat.

According to an embodiment, a seat receiving member for mounting a child seat to a transportation device includes a body for receiving the child seat thereon. The body forms an interface between the child seat and the transportation device. At least one light is associated with the body.

In addition to one or more of the features described above, or as an alternative, in further embodiments the body secures the child seat to the transportation device.

In addition to one or more of the features described above, or as an alternative, in further embodiments the transportation device is a vehicle.

In addition to one or more of the features described above, or as an alternative, in further embodiments the seat receiving member is a support base and the support base is positionable on a vehicle seat.

In addition to one or more of the features described above, or as an alternative, in further embodiments the at least one light is associated with the body to illuminate an interface between the seat receiving member and the child seat.

In addition to one or more of the features described above, or as an alternative, in further embodiments the seat receiving member includes a seat attachment movably mounted to the body and the at least one light is associated with the body to illuminate an interface between the seat attachment and the child seat.

In addition to one or more of the features described above, or as an alternative, in further embodiments the transportation device is a stroller.

In addition to one or more of the features described above, or as an alternative, in further embodiments the seat receiving member is a support member removably coupled to the stroller.

In addition to one or more of the features described above, or as an alternative, in further embodiments the at least one light is oriented toward the child seat.

In addition to one or more of the features described above, or as an alternative, in further embodiments the at least one light is associated with the body to illuminate an interface between the receiving member and the child seat.

In addition to one or more of the features described above, or as an alternative, in further embodiments the seat receiving member is a child seat underlay.

### BRIEF DESCRIPTION OF THE DRAWINGS

The following descriptions should not be considered limiting in any way. With reference to the accompanying drawings, like elements are numbered alike:

FIG. 1 is a perspective view of a child seat according to an embodiment;

FIG. 2 is a side view of a child seat mounted to a support base according to an embodiment;

FIG. 3 is a perspective view of a child seat mounted directly to a vehicle seat according to an embodiment;

FIG. 4 is a perspective view of a child seat to be mounted directly to a vehicle seat according to another embodiment;

FIG. 5 is a perspective view of a child seat mounted to a vehicle seat via a support base according to another embodiment;

FIG. 6 is a side view of a child seat mounted to a stroller according to an embodiment;

FIG. 7 is a side view of a child seat mounted to a stroller according to another embodiment;

FIG. 8 is a bottom view of a child seat according to an embodiment;

FIG. 9 is a perspective view of a support base according to an embodiment;

FIG. 10 is a perspective view of a child seat underlay according to an embodiment; and

FIG. 11 is a perspective view of a child seat mounted about a child seat underlay according to an embodiment.

### DETAILED DESCRIPTION

A detailed description of one or more embodiments of the disclosed apparatus and method are presented herein by way of exemplification and not limitation with reference to the Figures.

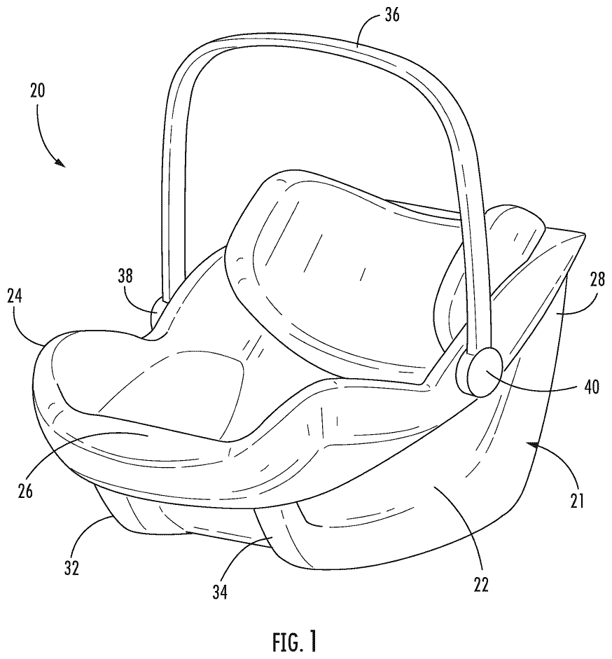

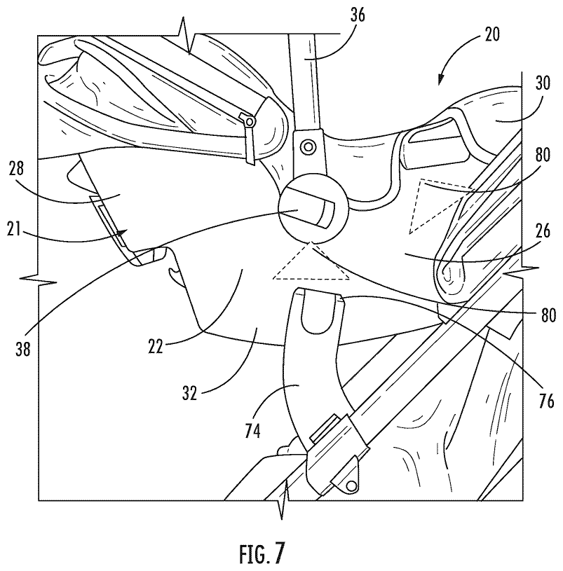

With reference to FIG. 1, an example of a child seat 20 is illustrated. The child seat 20 can include a seat body 21 formed from a seat shell 22 and in some embodiments a seat rim 24. The seat shell 22 alone or in combination with the seat rim 24 may define a child seat pan 26 and a child seat back 28 of the seat body 21. The child seat back 28 is typically arranged at an angle relative to the child seat pan 26. The child seat pan 26 and the child seat back 28 may be detachably coupled, or alternatively, may be permanently coupled. In some embodiments, the seat shell 22 may be a single, substantially solid, or partially hollow structure defining the child seat pan 26 and the child seat back 28. One or more seat pads, cushions, or the like 30 (see FIG. 7) may be disposed in overlapping arrangement with one or more surfaces of the child seat pan 26 and/or with one or more surfaces of the child seat back 28 to comfortably support a child that is positioned within the child seat 20.

In some embodiments, such as when the child seat 20 is an infant child seat for example, the bottom of the seat shell 22 may include a first seat shell rail 32 and a second seat shell rail 34 arranged at opposing sides of the child seat 20. In some configurations, the first and second seat shell rails 32, 34 may have respective curved rocker bottoms to enable a rocking motion to comfort a child positioned within the child seat 20 when the child seat is supported on a generally flat or planar surface (e.g., in a home environment, restaurant, etc.).

Alternatively, or in addition, the child seat 20 may include a carrying handle 40. In the illustrated, non-limiting embodiment, the carrying handle 36 has a generally arcuate shape and the two opposite ends 38, 40 thereof are respectively connected with a left and right side of the seat body 21 via respective attachment mechanisms (not shown). In some embodiments, the carrying handle 36 is movably connected with the seat shell 22 and/or the seat rim 24. Accordingly, the carrying handle 36 may be transformable, for example rotatable, between a plurality of positions or angles relative to the seat body 21, such as to more easily access the child positioned within the child seat 20 or for storage purposes for example. In some embodiments, the attachment mechanisms used to affix the handle to the seat body 21 may include integrated locking mechanisms (not shown) to maintain the carrying handle 36 at a desired orientation with respect to the seat shell 22.

It should be appreciated that the child seat 20 as illustrated and described herein is intended as an example only and that a child seat having any suitable configuration is within the scope of the disclosure. Further, although the child seat 20 is described herein with reference in some embodiments to an infant child seat, it should be appreciated that in other embodiments, the child seat 20 may be a convertible child seat. As used herein, the term “convertible child seat” refers to a seat that may be used in both a rearward and forward-facing direction such as suitable for use by a child between 5 and 65 pounds, and/or up to 49″ in height. The convertible child seat may also be referred to herein as an upright child seat or a toddler seat. Similarly, as used herein, the term “infant child seat” refers to such a seat as would be defined by one of ordinary skill in the art. For example, an infant child seat may be described as a seat for use by an infant or child too small to use a convertible child seat and may include a carrying handle, such as handle 36 for example, to allow for portability of the infant child seat external to the vehicle.

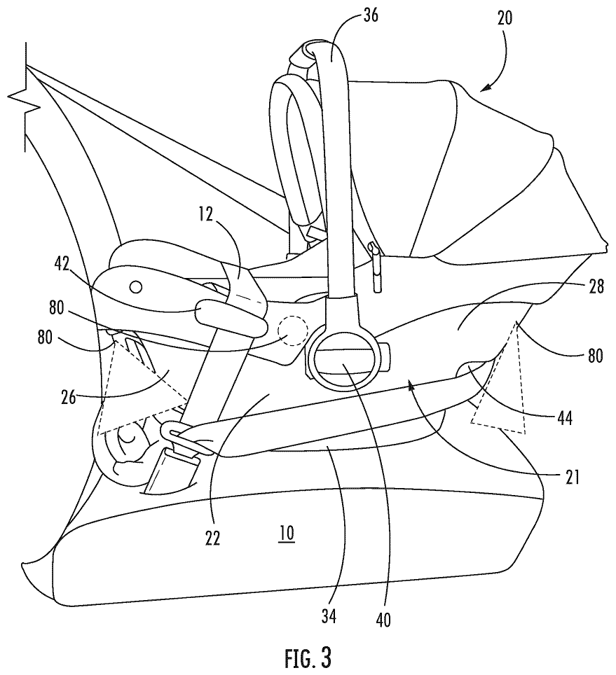

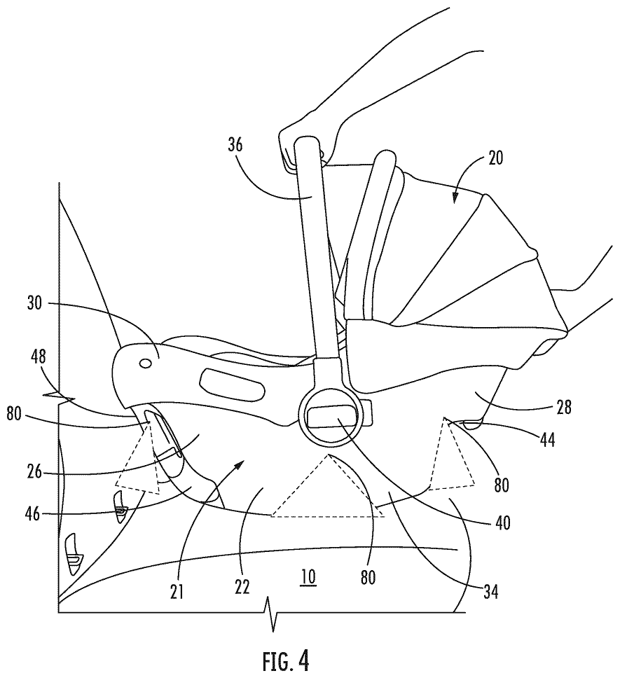

The child seat 20 may be suitable for use with a transportation device to transport a child. One such transportation device is a vehicle, such as an automobile or other motor vehicle having one or more vehicle seats therein for example. The child seat 20 may be installable directly on the vehicle seat 10 without the use of a separate base. In such instances, as shown in FIGS. 3 and 4, at least a portion of a bottom surface of the child seat 20, such as the first and second seat shell rails 32, 34 for example, may be arranged in direct contact with the vehicle seat 10. When the child seat 20 is mounted directly on the vehicle seat, the child seat 20 may be detachably fixed to the vehicle seat 10 via a vehicle belt 12 (FIG. 3) associated with the vehicle seat 10. In the illustrated, non-limiting embodiment, the vehicle belt 12 is arranged along a vehicle belt path defined by at least one vehicle belt guide tab 42 mounted to the seat body 21 and/or by a groove or pathway 44 formed at or adjacent to the exterior surface of the child seat back 28 of the seat body 21. Although a vehicle guide tab 42 is illustrated and described herein, it should be appreciated that in other embodiments, the child seat 20 may additionally or alternatively include a lock-off member (not shown) operable, for example rotatable relative to the seat shell 22, to apply a tension to the vehicle belt 12 when arranged along the vehicle belt path. Alternatively, or in addition, the child seat 20 may detachably couple to the vehicle seat 10 via a latch or anchor system (FIG. 4). The latch or anchor system often used is sometimes referred to as a “lower anchor and tether for children” e.g., LATCH system, and a connector 46 of the LATCH system may be integrated into the child seat 20, such as near a front end 48 thereof. It will be appreciated that the LATCH system can comprise a rigid anchor system or a belted anchor system. The rigid anchor system can include, for example, at least one anchor connected to the child seat 20 that can slide and/or rotate relative to the child seat 20 but is otherwise fixed to the child seat 20.

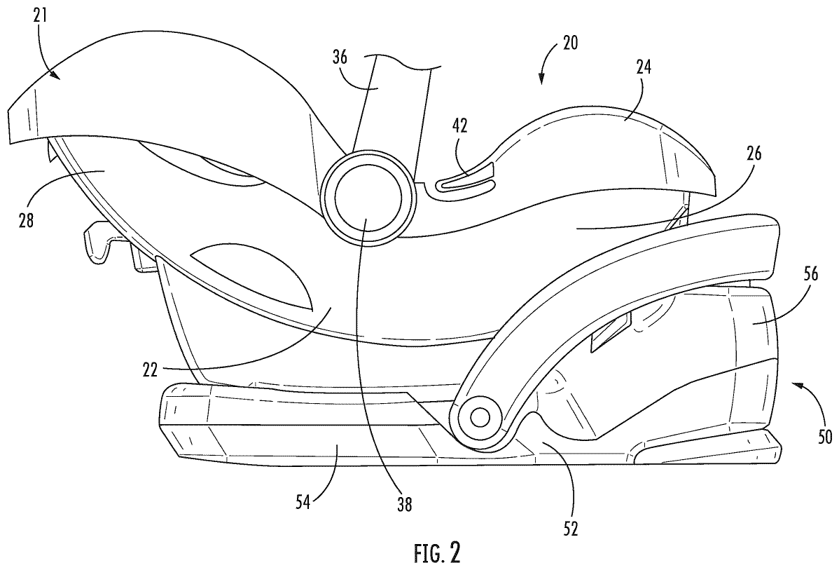

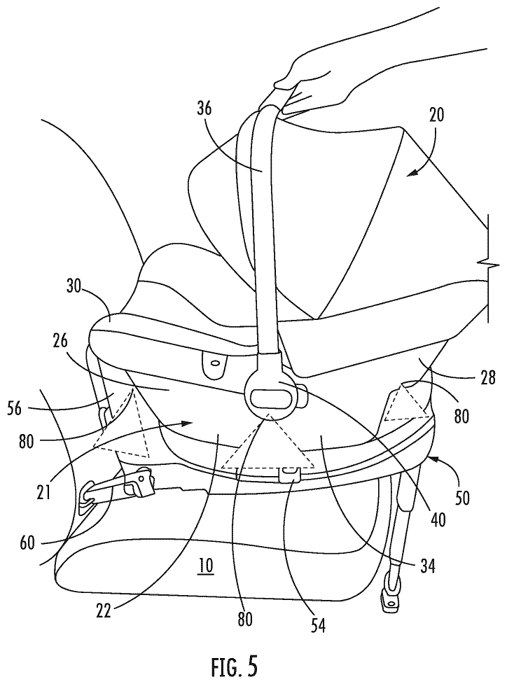

In other embodiments, the child seat 20 is part of a child restraint system including one or more seat receiving members for connecting the child seat 20 to a transportation device. The child seat 20 may be permanently or removably coupled to a seat receiving member to transport the child in a suitable manner. In an embodiment, best shown in FIG. 2, the one or more seat receiving members includes a support base 50. The support base 50 may be positionable in direct contact with a support surface, such as of a vehicle seat 10 for example, and may be attached to the vehicle seat 10 via a connector 60 of a LATCH system (FIG. 5). In the illustrated, non-limiting embodiment, the support base 50 includes a rigid body 52 adapted to support the child seat 20 thereon. The rigid body 52 typically includes a base seat portion 54 and a base backrest portion 56 extending at an angle relative to the base seat portion 54. However, embodiments where the support base 50 has another configuration are also contemplated herein.

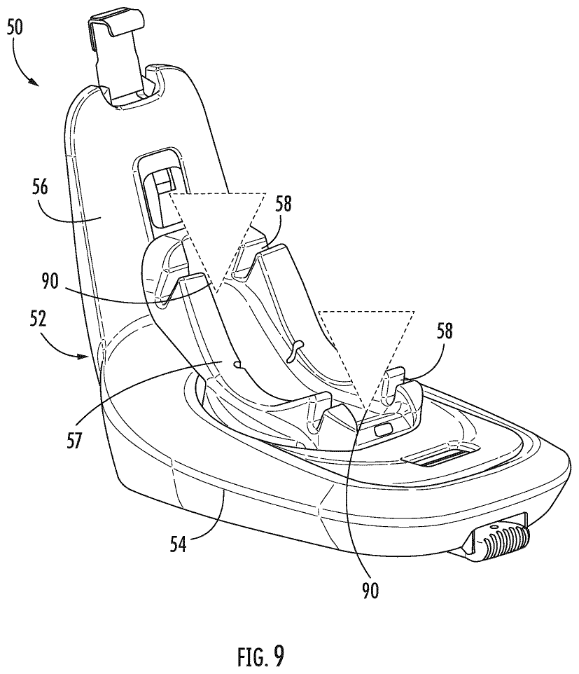

The child seat 20 may be selectively connected to the support base 50 in a known manner. In an embodiment, one or more seat engagement members (not shown) are arranged at the bottom of the child seat 20, such as between the seat shell rails 32, 34. With reference to FIG. 9, the support base 50 may include a seat attachment 57 movable, for example rotatable, relative to the rigid body 52 and having one or more base engagement members 58 corresponding to the one or more seat engagement members. In an embodiment, the seat engagement members are shafts and the base engagement members 58 are grooves or recesses within which the shafts are receivable. Although the grooves 58 are shown as being formed as recesses in the seat attachment 57 each being sized to receive and hold a respective shaft of the child seat 20 for example, in other embodiments, the grooves 58 may be formed in an upper surface of the rigid body 52. Although not shown, it should be appreciated that each of the base engagement members 58 can include a catch with which a corresponding latch can engage to lock the child seat 20 to the support base 50. In an embodiment, the connection between the seat engagement members and base engagement members forms an interface for mounting the child seat 20 to a seat receiving member such as the support base 50.

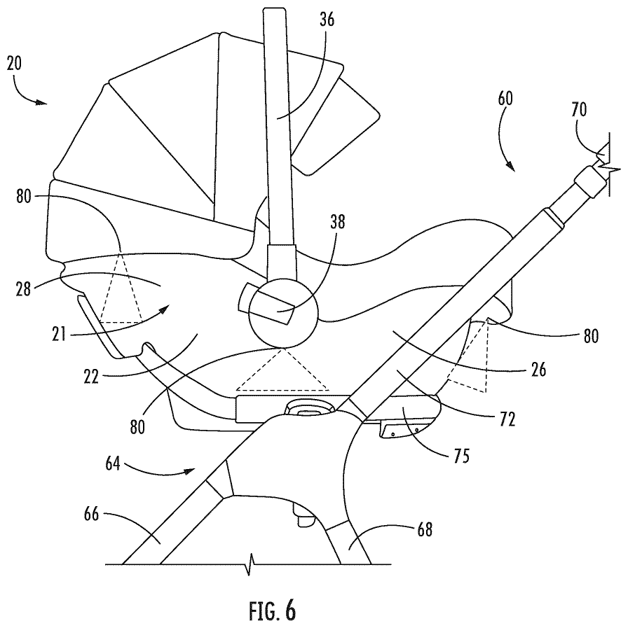

With reference now to FIGS. 6 and 7, in another embodiment, the transportation system comprises a stroller 62. The stroller 62 is configured to receive the child seat 20. As is known, the frame 64 of a stroller 62 typically includes a front leg 66 having at least one front wheel (not shown) coupled thereto, a rear leg 68 having at least one rear wheel (not shown) coupled thereto, and a handle 70. One or more connecting members 72 may couple the handle 70 to the front leg 66 and/or rear leg 68. The child seat 20 may be connectable to the frame 64 of a stroller 62 via one or more seat receiving members, such as adapters or support members for example. The adapters or support members may be permanently or detachably connected to the frame 64. In the non-limiting embodiment of FIG. 7, the child seat 20 is connectable to the stroller 62 via a plurality of support members 74. For example, a first support member 74 extends from a first side of the frame 64, such as from a first connecting member 72, and a second support member (not shown) extends from a second, opposite side of the frame 64, such as from a second connecting member (not shown).

The first and second support members 74, such as the distal ends 76 thereof, may be connectable to a corresponding portion of the child seat 20. In the illustrated, non-limiting embodiment, the support members 74 are connectable to the seat shell 22 adjacent to the two ends 38, 40 of the carrying handle 36, or alternatively, are connectable to the two ends 38, 40 of the carrying handle 36 themselves. However, embodiments where the support members 74 are connectable to another portion of the child seat 20 are also contemplated herein. The support members 74 may be considered to form an interface for mounting the child seat 20 to a transportation device such as the stroller 62.

In another embodiment, as illustrated in FIG. 6, a single support member 75 is connectable to the stroller 62 to receive the child seat 20. In the illustrated, non-limiting embodiment, the support member 75 has a continuous shape that defines a central opening (not shown) within which the bottom of the child seat 20, such as the seat shell rails 32, 34 for example, is positionable. It should be appreciated that the child seat 20 may be connected to only one transportation device, and the at least one seat receiving member corresponding to the transportation device at a time, and therefore the various seat receiving members illustrated and described herein are interchangeable. Further, it should be understood that the seat receiving members illustrated and described herein are intended as examples only and that any suitable seat receiving member is within the scope of the disclosure.

The child seat 20 may include at least one light 80, and in some embodiments a plurality of lights, selectively operable to illuminate a surrounding area. It should be appreciated that each light 80 referred to herein includes at least one light source, such as a single light source, or alternatively, a plurality of light sources. Further, in embodiments including a plurality of lights, the size, shape, color, and brightness, of each of the plurality of lights may be the same or may be different. In an embodiment, the one or more lights 80 are permanently affixed to or integral with the seat body 21, such as the seat shell 22 or seat rim 24 for example. In an alternative aspect, the one or more lights 80 can be detachably connected to the child seat 20. For example, the one or more lights 80 can be removed from the child seat 20, recharged, and reattached to the child seat 20. In another example, a damaged light 80 can be removed and replaced with a properly functioning light 80.

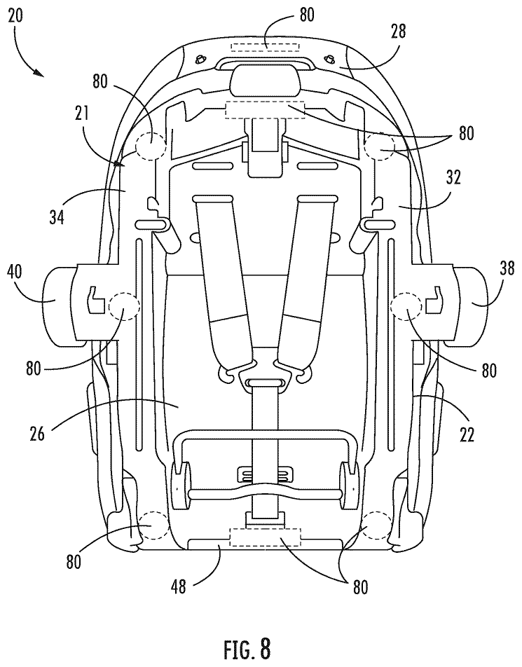

With reference to FIG. 8, one or more lights 80 may be mounted adjacent to or at the bottom of the seat shell 22. For example, in the illustrated, non-limiting embodiment, a first light is positioned near the end of each of the seat shell rails 32, 34 adjacent to the front end 48 of the seat shell 22, a second light is positioned near the end of the seat shell rails 32, 34 located adjacent to the child seat back 28 or back end of the seat shell 22, and one or more lights, referred to herein as a third light, may be arranged between the first and second lights at a central portion of the seat shell rails 32, 34. Alternatively, or in addition, one or more lights may be mounted to the bottom of the seat shell 22, at a location generally between the first and second seat shell rails 32, 34, such as near the front end 48 and/or the child seat back 28 of the seat shell 22 for example.

At least one light 80 may be positioned about the child seat 20 to facilitate installation or removal of the child seat 20 to a transportation device. For example, the at least one light may be positioned to aide in connecting or disconnecting the child seat 20 to the transportation device directly or to a seat receiving member associated with a transportation device. In an embodiment, the at least one light 80 is positioned about the exterior of the seat body 21 to illuminate an interface of the child seat 20 with a vehicle seat 10 and/or a seat receiving member. For example, as shown in FIGS. 2-4. the child seat 20 may include at least one light 80 arranged at the front end 48 of the seat shell 22, such as near a front edge of the child seat pan 26, vertically offset from the bottom of the seat shell 22. Such a light 80 may be oriented in any suitable manner, such as downwardly for example, to illuminate the connector 46, 60 of the LATCH system arranged at the bottom of the child seat 20 and/or near the base backrest portion 56 of the support base 50. In embodiments where the child seat 20 is connectable to a support member 74 of a stroller 62, such a light 80 may be positioned to illuminate an adjacent portion of the support member 74 (see FIG. 6).

Alternatively, or in addition, the child seat 20 may include at least one light 80 arranged near the backside of the seat shell 22, such as near the child seat back 28 of the child seat 20 or the interface between the child seat pan 26 and the child seat back 28. The one or more lights 80 arranged near the child seat back 28 of the seat shell 22 may be configured to illuminate a groove at the backside of the seat shell 22, a front edge of the vehicle seat 10 and/or a front edge of the support base 50 for example. The one or more lights 80 arranged at the backside of the seat shell 22 may be oriented to emit light generally downwardly. In embodiments where the child seat 20 is connectable to a support member 74, 75 of a stroller 62, the light 80 may be positioned to illuminate an adjacent portion of the support member 74, 75 such as a portion of the support member 75 receivable within groove 44 for example (FIG. 6).

In an embodiment, one or more lights 80 may be mounted near an end 38, 40 of the carrying handle 36. In the non-limiting embodiment of FIG. 3, the at least one light 80 is mounted to the seat body 21 and is positioned near the seat rim 24, between the end 38, 40 of the carrying handle 36 and a vehicle belt guide tab 42. Such a light 80 may be operable to illuminate the carrying handle 36, the vehicle belt guide tab 42 and its associated portion of a vehicle belt path, or both. In another embodiment, best shown in FIG. 4, at least one light 80 is arranged at the seat shell 22, generally underneath or behind the end 38, 40 of the carrying handle 36. However, embodiments where a light 80 is alternatively or additionally integrated into the carrying handle 36 itself are also within the scope of the disclosure. A light 80 positioned at or underneath an end 38, 40 of the carrying handle 36 may simply be configured to illuminate the portion of the child seat 20 not illuminated by the lights at the front end 48 or backside of the child seat 20. Alternatively, inclusion of a downwardly projecting light at or underneath an end 38, 40 of the carrying handle 36 may be configured to illuminate a corresponding support member 74 of a stroller 62 connectable to the child seat 20 near the end 38, 40 of the carrying handle 36, as shown in FIG. 5.

The one or more lights 80 of the child seat 20 may be operable automatically, such as in response to an input. For example, the lights 80 may be activated or energized in response to operation or application of a force to a button, a switch, or other actuator located about the child seat 20, such as associated with a release mechanism for selectively decoupling the child seat 20 from a support base for example. In other embodiments, the one or more lights 80 may be operable in response to movement of a component of the child seat 20, such as rotation of the carrying handle 36 relative to the seat shell 22 and/or movement of the connector 46 of the LATCH system relative to the seat shell 22. In an embodiment, the one or more lights 80 may be operated or selectively energized for a predetermined period of time, such as via a timer. For example, the at least one light 80 may turn off automatically after 30 seconds, 45 seconds, a minute, or two minutes. In other embodiments, the at least one light 80 may automatically turn off in response to connecting the child seat 20 with a seat receiving member, such as the support base 50 or a support member 74 for example. In an embodiment, the one or more lights 80 can be operably connected to one or more sensors. The one or more sensors can include, for example, a proximity sensor, a pressure sensor, or other sensor for sensing a proximity of the child seat 20 to a vehicle seat or stroller seat, a movement of a component of the child seat 20, a position or configuration of the anchor 60 on the child seat 20, or for sensing other situations or actions. The one or more sensors can be configured to transmit a signal to the one or more lights 80 for activation and/or deactivation.

Alternatively, or in addition to the at least one light 80 located at the child seat 20, at least one of the seat receiving members connectable with the child seat 20 may have one or more lights 90 located thereon. With reference to FIG. 9, an example of a support base 50 having at least one light 90 associated therewith is shown. The at least one light 90 of the support base 50 may be positioned to illuminate an interface between the support base 50 and the child seat 20. In the illustrated, non-limiting embodiment, the at least one light 90 is located at the movable seat attachment 57 and is aimed generally upwardly to illuminate one or more of the grooves 58 for coupling to the child seat 20. In other embodiments, the at least one light 90 may be mounted to the rigid body 52 of the support base 50 and oriented to illuminate an area or interface where the child seat 20 connects to the support base 50. Although not shown, the support base 50 may include one or more lights 90 operable to illuminate an interface between the support base 50 and a vehicle seat 10. For example, a light 90 may be positioned about the support base 50 to illuminate a connector 60 of the LATCH system and/or the seat back or an area of a vehicle seat 10 including an anchor (not shown) of the LATCH system to which the connector 60 is connectable to secure the support base 50. Similarly, although not shown, one or more lights may be mounted about the stroller 62, such as to illuminate an interface between the at least one support member 74 and the child seat 20. In an embodiment, the one or more lights may be positioned at the support members 74, at a portion of the frame 64 adjacent to the support members 74, or at another portion of the frame 64 for example, such as a handle or button operable to collapse the stroller for example.

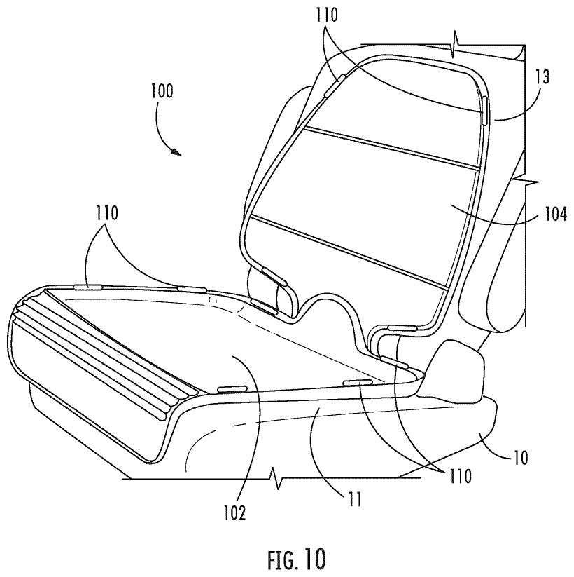

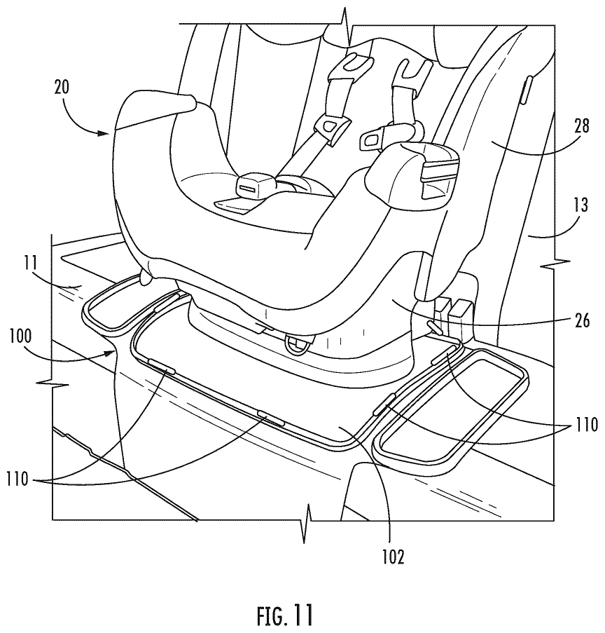

With reference now to FIGS. 10 and 11, in an embodiment, another type of seat receiving member for mounting a child seat to a transportation device, such as a motor vehicle, is illustrated. As shown, the seat receiving member is a child seat underlay 100 positionable between the child seat 20 and the vehicle seat 10. In the illustrated, non-limiting embodiment, the child seat underlay 100 is formed from a plastic or elastic material, such as rubber for example, and has a body including an underlay seat portion 102. It will be appreciated that the child seat underlay 100 can be formed from other materials, such as fabric materials for example. As shown, the underlay seat portion 102 is typically larger in size than that bottom of the child seat 20 positionable thereon and may extend over the front edge of the vehicle seat 10. In some embodiments, the child seat underlay 100 additionally includes an underlay back portion 104 coupled to or separate from the underlay seat portion 102. The underlay seat portion 102 is positionable between the bottom of the child seat 20 and a corresponding surface 11 of the vehicle seat 10 and the underlay back portion 104 is positionable between the child seat back 28 and a corresponding seat back 13 of the vehicle seat 10.

In an embodiment, one or more lights 110 are embedded within the child seat underlay 100. The at least one light 110 may be arranged at any position about the child seat underlay 100 that is not typically covered by a child seat 20, and therefore is visible to a user. As shown, the lights 110 may be positioned about a border of the underlay seat portion 102 and/or the underlay back portion 104. In embodiments including a plurality of lights 110, the lights 110 may extend continuously about the periphery or may be uniformly or non-uniformly spaced about the periphery. However, embodiments where the lights are arranged at another location about the child seat underlay are also contemplated herein.

In an embodiment, the one or more lights 110 can be operably connected to one or more sensors. The one or more sensors can be positioned on or about the child seat underlay 100. The one or more sensors can include, for example, a proximity sensor, a pressure sensor, or other sensor for sensing a proximity of the child seat 20 to the child seat underlay 100, a movement of a component of the child seat 20 on the child seat underlay 100, or for sensing other situations or actions. The one or more sensors can be configured to transmit a signal to the one or more lights 110 for activation and/or deactivation.

Inclusion of lights into the child seat 20, the transportation device, the child seat underlay 100, or a seat receiving member arranged at the interface between the child seat 20 to the transportation device are intended to provide a user with greater visibility during installation and removal of the child seat from the transportation device and during installation and separation of a child from the child seat.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A child seat mountable to a transportation device, the child seat comprising:
a seat body including a seat shell having a child seat pan and a child seat back, said seat body being securable to the transportation device; and
at least one light mounted about said seat body.

2. The child seat of claim 1, wherein said at least one light is positioned such that said at least one light is operable to illuminate an interface between the child seat and the transportation device.

3. The child seat of claim 2, wherein the transportation device is an automobile including a vehicle seat.

4. The child seat of claim 3, wherein said seat body further comprises a connector of a LATCH system and said at least one light is operable to illuminate said connector.

5. The child seat of claim 3, wherein said seat body further comprises a vehicle belt path for a vehicle belt associated with the vehicle seat, and wherein said at least one light is operable to illuminate a portion of said vehicle belt path.

6. (canceled)

7. (canceled)

8. The child seat of claim 2, wherein said child seat is connectable to the transportation device via a seat receiving member and said at least one light is positioned about said child seat such that said at least one light is operable to illuminate an interface between said child seat and said seat receiving member.

9. The child seat of claim 8, wherein the transportation device is a stroller, and said seat receiving member is a support member of said stroller.

10. The child seat of claim 8, wherein said seat body further comprises a carrying handle movably mounted to said seat shell, said at least one light being positioned adjacent to said carrying handle.

11. (canceled)

12. The child seat of claim 8, wherein said seat receiving member is a support base and the transportation device is an automobile including a vehicle seat.

13. The child seat of claim 1, wherein said child seat is connectable to the transportation device via a seat receiving member, and wherein said at least one light is positioned about said child seat to illuminate an interface between said seat receiving member and the transportation device.

14. The child seat of claim 13, wherein said at least one light is oriented to emit light towards said seat receiving member.

15. The child seat of claim 1, wherein said at least one light is oriented to emit light towards a portion of the transportation device.

16. (canceled)

17. (canceled)

18. A child seat mountable to a transportation device, the child seat comprising:
a seat body including a seat shell; and
at least one light mounted about said seat body, said at least one light being activatable in response to an input to said seat body.

19. The child seat of claim 18, wherein said seat body further comprises a connector of a LATCH system and said at least one light is activatable in response to movement of said connector.

20. The child seat of claim 18, wherein said seat body further comprises a carrying handle movably mounted to said seat shell, said at least one light being activatable in response to movement of said carrying handle.

21. The child seat of claim 18, wherein said seat body further comprises a release mechanism having an actuator, said at least one light being activatable in response to application of a force to said actuator.

22. The child seat of claim 18, wherein said child seat is an infant child seat.

23. A seat receiving member for mounting a child seat to a transportation device, the seat receiving member comprising:
a body for receiving the child seat thereon, wherein said body forms an interface between the child seat and the transportation device; and
at least one light associated with said body.

24. The seat receiving member of claim 23, wherein said body secures the child seat to the transportation device.

25. The seat receiving member of claim 24, wherein the transportation device is one of a vehicle and a stroller.

26. The seat receiving member of claim 25, wherein the transportation device is a stroller and the seat receiving member is a support base, said support base being positionable on a vehicle seat.

27. (canceled)

28. (canceled)

29. (canceled)

30. (canceled)

31. The seat receiving member of claim 23, wherein said at least one light is oriented toward the child seat.

32. The seat receiving member of claim 31, wherein said at least one light is associated with said body to illuminate an interface between said the receiving member and the child seat.

33. The seat receiving member of claim 23, wherein the seat receiving member is a child seat underlay.
